(19) United States
(12) Patent Application Publication
(10) Pub. No.: US 2025/0208095 A1
(43) Pub. Date: Jun. 26, 2025

(54) CYCLIC VOLTAMMETRIC EVALUATION OF MATERIALS

(71) Applicant: Celgard, LLC, Charlotte, NC (US)

(72) Inventors: Zhengming Zhang, Rock Hill, SC (US); Wenbin Yin, Charlotte, NC (US)

(21) Appl. No.: 18/847,305

(22) PCT Filed: Mar. 15, 2023
(86) PCT No.: PCT/US2023/015320

§ 371 Date: Sep. 16, 2024

Related U.S. Application Data
(60) Provisional application No. 63/320,716, filed on Mar. 17, 2022.

(51) Int. Cl. G01N 27/48; G01N 27/30; G01N 27/403; H01M 10/0525; H01M 10/42

(52) U.S. Cl. CPC G01N 27/48; G01N 27/301; G01N 27/403; H01M 10/4285; H01M 10/0525

(57) ABSTRACT

Systems and methods of evaluating the electrochemical stability of material are provided comprising providing an electrochemical cell having a tube cell, electrolyte material, and at least one reference electrode and at least one working electrode. The working electrode can be at least one of aluminum and copper foil. In some instances, the working electrode can be coated with a test material. In some other instances, the electrolyte material can be pretreated with a test material. The electrochemical cell can be subjected to a cyclic voltammetry procedure in part to determine physical and/or chemical attributes of the test material.

### RELATED APPLICATION DATA

This Application is a 371 U.S. Application which claims priority to PCT Application No. PCT/US2023/015320, filed Mar. 15, 2023, which claims priority to U.S. Provisional Application No. 63/320,716, which was filed on Mar. 17, 2022, and is incorporated herein in its entirety.

### FIELD

The technology described herein generally relates to materials testing and evaluation, and more specifically, to systems, equipment, apparatus, and methods of testing or otherwise evaluating the electrochemical stability of materials, such as battery materials or components.

### BACKGROUND

When new chemicals or materials are to be used or otherwise incorporated into coatings or other aspects of components utilized in ionic batteries, such as new chemicals and additive materials in lithium ion battery electrolyte, electrochemical stability of these new chemicals or materials needs to be evaluated prior to their incorporation into batteries or battery components.

Consequently, there is a need for improved methods and apparatus for testing or otherwise evaluating materials, such as the electrochemical stability of materials, that provides more accurate and reliable results.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein are directed towards methods and apparatus for testing or otherwise evaluating materials, for example electrochemical attributes of such materials. In some aspects, testing or otherwise evaluating materials can include evaluating the electrochemical stability of such materials.

According to some embodiments, a method for evaluating the electrochemical stability of a material is provided, the method comprising preparing a testing sample comprising a test material. In some embodiments, preparing the testing sample can include dip coating a test material onto an aluminum foil. In some other embodiments, preparing the testing sample can include dip coating a test material onto a copper foil. Reference and working electrodes can subsequently be formed for use (e.g. in an electrochemical cell) where the reference electrode is formed in part by a lithium foil and the working electrode is formed from the prepared testing sample. A tube cell may be formed, for instance using poly tubing, such as high density polyethylene (HDPE) PE tubing or (Polytetrafluoroethylene) PTFE and electrolyte material and/or solution can be added to the tube cell. The reference electrode and one of the working electrodes can be added into opposite sides of the tube cell and the tube cell can be subjected to a cyclic voltammetry procedure.

According to some further embodiments, a method for evaluating the electrochemical stability of a material is provided, the method comprising preparing a testing sample comprising a test material, which in some instances may be an electrolyte material treated with a test material. Reference and working electrodes can subsequently be formed for use (e.g. in an electrochemical cell) where the reference electrode is formed in part by a lithium foil and the working electrode is formed from one of aluminum foil and copper foil. A tube cell may be formed, for instance using poly tubing, such as HDPE or PTFE tubing and electrolyte material and/or solution can be added to the tube cell, where the electrolyte solution comprises the testing sample. The reference electrode and one of the working electrodes can be added into opposite sides of the tube cell and the tube cell can be subjected to a cyclic voltammetry procedure.

According to some even further embodiments a system for evaluating the electrochemical stability of a material is provided comprising a tube cell comprising electrolytic solution, a reference electrode comprising lithium, and a working electrode, wherein the system can be subjected to a cyclic voltammetry procedure. In some instances, the working electrode is one of an aluminum foil and a copper foil. In some other instances, the working electrode is coated with a test material. In some even further instances, the electrolytic solution comprises an electrolyte pretreated with a test material.

Additional objects, advantages, and novel features of the invention will be set forth in part in the description which follows, and in part will become apparent to those skilled in the art upon examination of the following, or can be learned by practice of the invention.

### BRIEF DESCRIPTION OF THE DRAWINGS

Aspects of the technology presented herein are described in detail below with reference to the accompanying drawing figures, wherein:

FIG. 1 shows a diagram of example aspects of an apparatus for evaluating the electrochemical stability of a material, in accordance with some aspects of the technology described herein;

FIG. 2 is a flow diagram showing an example method for evaluating the electrochemical stability of a material, in accordance with some aspects of the technology described herein;

FIG. 3 is a flow diagram showing an example method for evaluating the electrochemical stability of a material, in accordance with some aspects of the technology described herein; and,

FIG. 4 is a graphical diagram showing the results of an example test of a standard binder and heated electrolyte using the present method for evaluating the electrochemical stability of a binder material, in accordance with some aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps disclosed herein unless and except when the order of individual steps is explicitly described.

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Embodiments of the technology described herein are directed towards methods and apparatus for testing or otherwise evaluating materials. In some aspects, testing or otherwise evaluating materials can include evaluating the electrochemical stability of such materials. When new materials are used in various processes and systems, for instance in

[symbol]

Described herein are apparatus and methods for evaluating the electrochemical stability of materials, chemicals, and/or additives, for example those which may be used in Lithium-ion battery electrolyte. In one example, the electrochemical stability of polyvinylidene fluoride (PVDF) may be evaluated prior to incorporation into electrolyte for battery technology. In another example, binder material used in coatings for electrochemical applications may be evaluated for stability.

In some embodiments, an apparatus or system is provided for use in evaluating the electrochemical stability of materials. The apparatus or system can include, amongst other components, a plurality of electrodes, implemented as a two-electrode configuration or a three-electrode configuration, poly tubing (e.g. polyethylene (PE) tubing), a metal, such as lithium metal, electrolyte solution, which is to be evaluated, wire for fixing metal foils in the apparatus or system (such as copper wire), and one or more clips for holding electrodes in a cell setup. In some instances, the electrodes may include a reference electrode and a counter electrode. In some further instances, the electrodes may include a working electrode. In some example embodiments the reference electrode and the counter electrode are comprised of lithium metal foil. In some other example embodiments, the working electrode comprises one of an aluminum strip or foil and a copper strip or foil.

In some embodiments, a method for evaluating the electrochemical stability of a material is provided. Initially, samples for testing can be prepared by dip coating a material onto an aluminum foil and/or a copper foil. It will be appreciated that dip coating may be accomplished by a solution made of the material and one or more solvents. In some example embodiments, materials to be evaluated can be intially dried, subsequently soaked in electrolyte, and then baked. In one example embodiment, the electrolyte can be baked at about 80° C. for about a week.

In some embodiments, methods of evaluating the electrochemical stability of a material comprises cell and electrode preparation followed by a cyclic voltammogram procedure. Initially, a PE tube for each individual test can be prepared. It will be appreciated that the PE tube may be of any suitable length for the evaluation of materials. In some examples, the PE tube may be prepared to be about 3 inches to about 6 inches, more specifically about 4.5 inches. A wire, such as a copper (Cu) wire may be prepared having dimensions congruent with the PE tube, for example the copper wire may be about 4 inches. The copper wire can be implemented to fix a lithium (Li) foil reference and/or counter electrode. A strip of lithium foil having dimensions not inconsistent with this disclosure may be used, for example a lithium metal foul of about 0.5 inches by 0.25 inches may be prepared. The prepared lithium foil (e.g. for implementation as a reference and/or counter electrode) may then be wrapped around one end (e.g. a first end) of the copper wire, for instance completely wrapped around the first end of the copper wire completely such that the copper wire is not exposed. It will be appreciated that the lithium metal should adhere firmly to the copper wire. Subsequently, working electrodes may be prepared (e.g. Cu or Al depending on the test to be carried out) by cutting coated electrode samples do the desired dimensions, for example in some instances, the working electrodes may be prepared by cutting coated Cu or Al foil to specific dimensions, in one example embodiment the samples can have dimensions of about 2 mm width and 3 inches in length.

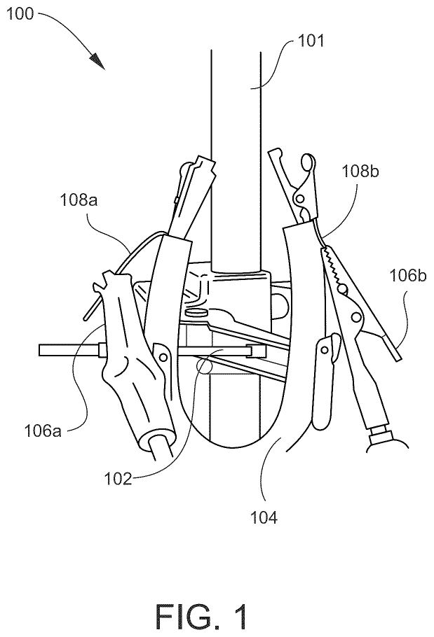

After preparation of the cell and electrode components, a cyclic voltammogram procedure can be utilized for the evaluation of the electrochemical stability of a material. Initially, the PE tubing may be bent, for example into a U-shape configuration, and inserted between one or more clamps (e.g. 102 of FIG. 1). It will be appreciated that the clamps can be set to a specified or required tightness to hold the PE tube cell upright. A solution of electrolyte material in a solvent (i.e. testing material and/or solution) can be added into the PE tube cell to subsequently determine the range of electrochemical potential of the material. In some embodiments, the testing material and/or solution a pretreated electrolyte combined with one or more solvents. It will be appreciated that a previously determined amount of electrolyte in solvent solution may be added to the PE tube cell, for instance at least 10 drops may be added to the PE tube cell.

One or more electrodes may then be implemented to carry out an electrochemical study. A working electrode (e.g. an aluminum electrode for an oxidation study, a copper electrode for a reduction study) can be placed into one side of the PE tube cell (e.g. a second side) such that the tip of the working electrode is positioned at or around the middle of the PE tube cell. A reference electrode, for example a lithium metal electrode, can be placed into the other side of the PE tube cell (e.g. a first side) such that the tip of the reference electrode is positioned at or around the middle of the PE tube cell. It will be appreciated that the reference electrode and the working electrode (i.e. coated electrodes) are configured such that they maintain close proximity within the PE tube cell, for example the reference electrode and the working electrode can be configured to be an inch or less apart. During testing, e.g. cyclic voltammogram testing, the electrodes can be held in place by one or more clips (e.g. 106a, 106b of FIG. 1).

Subsequently, the cell can be operated on, for instance cyclic voltammetry may be performed on the cell described above. In one example test, the test parameters for cyclic voltammetry can be set to 300 seconds for rest voltage, 5 mv/sec as a scan rate, 3 cycles, wherein the scanning range for a Cu foil is −1 to 1 V and the scanning range for a Al foil is 3 to 5 V.

In accordance with at least certain aspects, objects or embodiments, the present invention or disclosure may provide or include systems and methods of evaluating the electrochemical stability of materials comprising providing an electrochemical cell having a tube cell, electrolyte material, and at least one reference electrode and at least one working electrode. The working electrode can be at least one of aluminum and copper foil. In some instances, the working electrode can be coated with a test material. In some other instances, the electrolyte material can be pretreated with a test material. The electrochemical cell can be subjected to a cyclic voltammetry procedure in part to determine physical and/or chemical attributes of the test material.

Referring now to the figures, with reference to FIG. 1, an example apparatus 100 for evaluating the electrochemical properties of a material is illustrated. Apparatus 100 can include a clap stand 101 and one or more clamps 102, configured for stabilizing and/or holding a PE tube cell 104. Although note pictured, PE tube cell 104 can be implemented to receive and hold an electrolyte solution, for example an electrolyte in solvent solution. It will be appreciated that the testing material may can be prepared by drying a chemical or material to be tested, soaking it in electrolyte, drying the electrolyte and subsequently forming a solution with the dried material/electrolyte and one or more solvents (e.g. pre-treated electrolyte). Apparatus 100 can further include one or more electrodes 108a, 108b which can be placed into PE tube cell 104. A working electrode 108b formed from aluminum or copper (e.g. aluminum for an oxidation study or copper for a reduction study) can be placed into one side of the PE tube cell 104 (e.g. a second side) such that the tip of the working electrode is positioned at or around the middle of the PE tube cell 104. It will be appreciated that in some embodiments, the material to be tested is directly coated (e.g. via dip coating) onto the working electrode. A reference electrode 108a formed from lithium metal can be placed into the other side of the PE tube cell 104 (e.g. a first side) such that the tip of the reference electrode is positioned at or around the middle of the PE tube cell. The electrodes 108a, 108b can be fixed in place by one or more clips 106a, 106b.

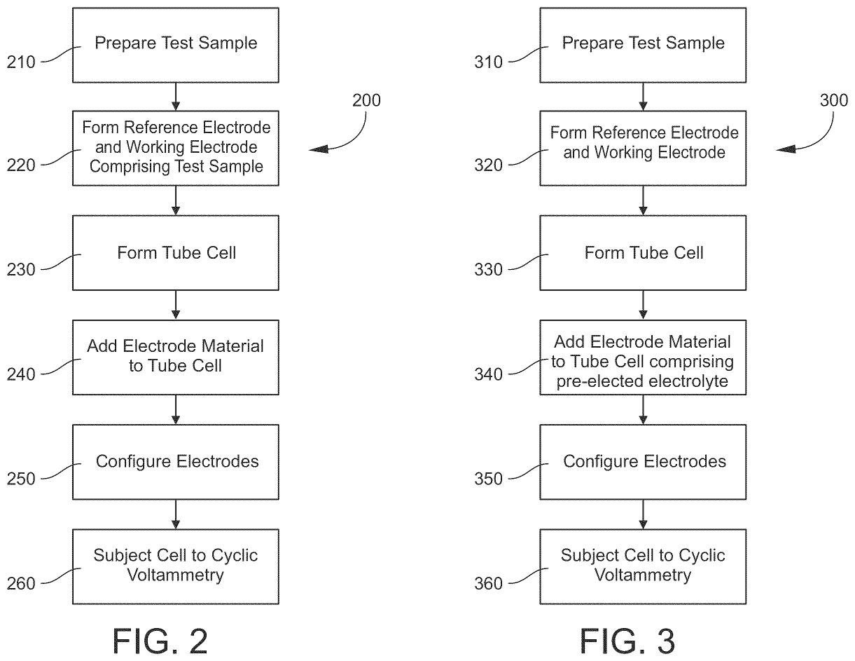

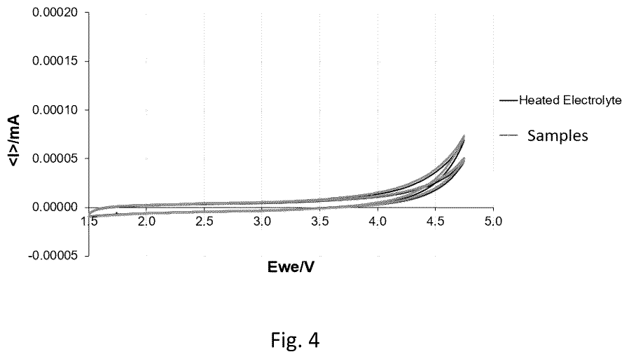

Turning now to FIG. 2, a flow diagram is provided illustrating one example method 200 for evaluating the electrochemical stability of a material. It is contemplated that method 200 and other methods described herein are not limited to those illustrated and can incorporate other blocks or steps at any point in the method in accordance with the present disclosure. At step 210 a material to be tested and/or evaluated can be provided and utilized to prepare a testing sample. The material to be tested can be coated (e.g. dip coated) onto one or more aluminum (Al) foils and/or one or more copper (Cu) foils. At step 220 one or more reference electrodes are prepared by completely wrapping lithium foil around a copper wire rode, and one or more working electrodes are prepared by cutting one or more of the prepared testing sample, i.e. cutting the coated aluminum foil and/or copper foil. At step 230 a PE tube cell is formed into a U-shaped configuration and secured in an upright position. At step 240 electrolyte combined with solvent is added to the PE tube cell to act as the electrolyte material for determining the range of potential of the cell. At step 250, the reference electrode is placed into one side of the tube cell such that the tip of the reference electrode is located at or about the middle of the PE tube cell, and one working electrode (e.g. coated aluminum electrode for an oxidation evaluation of the test material or coated copper electrode for a reduction evaluation of the test material) is place into the other side of the tube cell such that the tip of the working electrode is located at or about the middle of the PE tube cell. It will be appreciated that the reference electrode and the working electrode may be within a determined proximity from one another. At step 260 the electrodes are fixed and cyclic voltammetry is performed on the electrochemical cell to obtain data relating to the reduction and/or oxidation processes of the cells that incorporate the test materials.

Turning now to FIG. 3, a flow diagram is provided illustrating one example method 300 for evaluating the electrochemical stability of a material. At step 310 a material to be tested and/or evaluated can be provided and utilized to prepare a testing sample. The material to be tested can be dried and soaked in an electrolyte, and subsequently the electrolyte can be baked. At step 320 one or more reference electrodes are prepared by wrapping lithium foil over a copper wire rode, and one or more working electrodes are prepared by cutting aluminum foil and/or copper foil into a required dimension. At step 330 a PE tube cell is formed into a U-shaped configuration and secured in an upright position. At step 340 pre-treated electrolyte (e.g. the electrolyte of step 310) is combined with solvent and added to the PE tube cell to act as the electrolyte material for determining the range of potential of the cell. At step 350, the reference electrode is placed into one side of the tube cell such that the tip of the reference electrode is located at or about the middle of the PE tube cell, and one working electrode (e.g. aluminum electrode for an oxidation evaluation of the test material or copper electrode for a reduction evaluation of the test material) is place into the other side of the tube cell such that the tip of the working electrode is located at or about the middle of the PE tube cell. It will be appreciated that the reference electrode and the working electrode may be within a determined proximity from one another. At step 360 the electrodes are fixed and cyclic voltammetry is performed on the electrochemical cell to obtain data relating to the reduction and/or oxidation processes of the cells that incorporate the test materials

Accordingly, various aspects of the technology for the testing or evaluation of the electrochemical stability of materials are described. It is understood that various features, sub-combinations, and modifications of the embodiments described herein are of utility and can be employed in other embodiments without reference to other features or sub-combinations. Moreover, the order and sequences of steps shown in the example methods 200 and 300 are not meant to limit the scope of the present invention in any way, and the steps can occur in a variety of different sequences within various embodiments. Such variations and combinations thereof are also contemplated to be within the scope of embodiments of the invention.

Embodiments described herein can be understood more readily by reference to the following Examples. Elements, apparatus, and methods described herein, however, are not limited to any specific embodiment presented in the Examples. It should be recognized that these are merely illustrative of some principles of this disclosure, and are non-limiting. Numerous modifications and adaptations will be readily apparent without departing from the spirit and scope of the disclosure.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

1. A method of evaluating the electrochemical stability of a material, the method comprising:
preparing a testing sample comprising a test material;
forming a reference electrode and a working electrode, wherein the working electrode is formed from the testing sample;
forming a tube cell;
adding electrolyte solution to the tube cell;
inserting the reference electrode into a first side of the tube cell and inserting the working electrode into a second side of the tube cell; and
subjecting the tube cell to a cyclic voltammetry procedure.

2. The method of claim 1, wherein the reference electrode comprises lithium metal.

3. The method of claim 1, wherein the testing sample comprises dip coating the test material onto an aluminum foil.

4. The method of claim 1 wherein the testing sample comprises dip coating the test material onto a copper foil

5. The method of claim 1, wherein the reference electrode and the working electrode are less than an inch apart within the tube cell.

6. The method of claim 1, wherein the tube cell is a U-shaped configuration.

7. The method of claim 3, wherein the cyclic voltammetry procedure comprises a scanning range of about 3 to about 5 V.

8. The method of claim 4, wherein the cyclic voltammetry procedure comprises a scanning range of about −1 to about 1 V.

9. The method of claim 1, wherein the cyclic voltammetry procedure comprises at least one of a rest voltage of about 300 seconds and a scan rate of about 5 mV/sec.

10. A method of evaluating the electrochemical stability of a material, the method comprising:
preparing a testing sample comprising a test material;
forming a reference electrode and a working electrode;
forming a tube cell;
adding electrolyte solution to the tube cell, wherein the electrolyte solution comprises the testing sample;
inserting the reference electrode into a first side of the tube cell and inserting the working electrode into a second side of the tube cell; and
subjecting the tube cell to a cyclic voltammetry procedure.

11. The method of claim 10, wherein the reference electrode comprises lithium metal.

12. The method of claim 10, wherein the working electrode comprises an aluminum foil.

13. The method of claim 10, wherein the working electrode comprises a copper foil.

14. The method of claim 10, wherein preparing the testing sample comprises:
drying the test material;
soaking the dried test material in electrolyte; and
baking the treated electrolyte.

15. The method of claim 10, wherein the reference electrode and the working electrode are less than an inch apart within the tube cell.

16. The method of claim 12, wherein the cyclic voltammetry procedure comprises a scanning range of about 3 to about 5 V

17. The method of claim 13, wherein the cyclic voltammetry procedure comprises a scanning range of about −1 to about 1 V.

18. A system for evaluating the electrochemical stability of a material comprising:
a tube cell comprising electrolytic solution;
a reference electrode comprising lithium; and
a working electrode;
wherein the system is subjected to a cyclic voltammetry procedure.

19. The system of claim 18, wherein the working electrode is one of an aluminum foil and a copper foil.

20. The system of claim 19, wherein the working electrode is coated with a test material.

21. The system of claim 18, wherein the electrolytic solution comprises an electrolyte pretreated with a test material.

22. A system for evaluating the electrochemical stability of a battery material or component comprising:
a tube cell comprising electrolytic solution;
a reference electrode comprising lithium; and
a working electrode;
wherein the system is subjected to a cyclic voltammetry procedure.

23. A system for evaluating the electrochemical stability of a lithium ion battery material or component comprising:
a tube cell comprising electrolytic solution;
a reference electrode comprising lithium; and
a working electrode;
wherein the system is subjected to a cyclic voltammetry procedure.

24. The system of claim 23, wherein the material is a binder.
